(19) United States
(12) Patent Application Publication
(10) Pub. No.: US 2005/0165143 A1
(43) Pub. Date: Jul. 28, 2005

(54) Recording media

(76) Inventors: Kenichi Kawano, Ibaraki (JP); Hiroshi Kakihira, Ibaraki (JP)

Correspondence Address: HARNESS, DICKEY & PIERCE, P.L.C., P.O. BOX 8910, RESTON, VA, 20195, US

(21) Appl. No.: 10/504,074

(22) PCT Filed: May 30, 2003
(86) PCT No.: PCT/JP03/06894

(30) Foreign Application Priority Data
Jun. 7, 2002 (JP) 2002-166984

(51) Int. Cl. C08K 5/48

(52) U.S. Cl. 524/211

(57) ABSTRACT

A recording medium is composed of a base material and at least one ink-receiving layer arranged on at least one side of the base material. The ink-receiving layer contains at least one binder resin selected from a water-soluble resin and a water-dispersible resin, an inorganic pigment, a compound represented by the following formula (1): wherein R₁ to R₄ may be the same or different and each independently represents a hydrogen atom, an alkyl group, an aryl group or a group represented by —NR₅R₆, R₅ and R₆ each independently represents a hydrogen atom, an alkyl group having 1 to 5 carbon atoms, a phenyl group or a group represented by —NR₇CSNR₈R₉, R₇ to R₉ may be the same or different and each independently represents a hydrogen atom, an alkyl group having 1 to 5 carbon atoms or a phenyl group, and any one of R₁and R₂ and any one of R₃ and R₄ are not fused together to form a ring, an alkylamine-epihalohydrin copolymer, and a boron compound. The inorganic pigment, the compound represented by the formula (1), the alkylamine-epihalohydrin copolymer and the boron compound are contained in particular relative proportions.

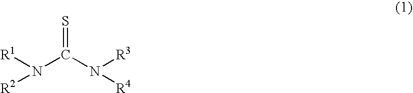

### TECHNICAL FIELD

This invention relates to recording media suitable for performing recording with ink, and especially to recording media provided with excellent gloss and printing characteristics and inhibited in image fading and discoloration by storage over extended time and also in dye migration after printing when applied to printers or plotters making use of ink-jet recording.

### BACKGROUND ART

Ink-jet recording is a recording technique that performs recording of an image, characters or the like by causing tiny droplets of ink to fly in accordance with one of various operation principles and then allowing them to deposit on a recording medium such as paper. Ink-jet recording features high-speed printing performance, low operating noise, applicability for the recording of a wide variety of characters and patterns, easy multi-color printing, and obviation of development and image fixing. In particular, an image formed by multi-color ink-jet recording can provide a record which is no way inferior to an image printed by multi-color printing making use of a form-plate-dependent printing technique or by a color photographic technique. Ink-jet recording has a still further merit in that, when the number of copies or prints to be made is small, ink-jet recording requires lower printing cost than an ordinary printing technique or photographic technique. Ink-jet recording is, therefore, rapidly finding wide-spread utility as image recorders for various information equipment in recent years. For example, ink-jet recording is finding increasing utility in a wide variety of fields in which recording of full-color images is required, for example, output of image designs in design business, production of color block copies in a printing field where the quality of photographic images is required, and production of billboards and catalogs which are frequently updated.

In such ink-jet recording, improvements have been made in recorders and recording methods to improve recording characteristics, for example, to achieve high-speed recording, high-definition recording and full-color recording. Keeping in step with such improvements, an increasing demand has also arisen for recording media of still higher characteristics. Described specifically, characteristics the demands for which have arisen with respect to recording media to obtain record images at high resolution and high quality comparable with those of silver halide pictures include:
(1) printed dots can have high density and can produce vivid and bright tones,
(2) high contrast can be produced,
(3) ink absorption property is so high that, even when printed dots overlap, ink does not run off or bleed,
(4) spreading or diffusion of ink in horizontal direction does not occur beyond necessity and printed dots have a shape close to a true circle, and
(5) dots are smooth along their peripheries and are well defined.

To meet these requirements, certain proposals have been made to date. For example, JP 52-53012 A discloses ink-jet recording paper of the ordinary plain paper type equipped with ink absorption property increased by applying a surface-processing coating formulation as a thin layer to a base paper stock of low sizing. Other patent publications disclose ink-jet recording media of the coated type each obtained by applying a coating formulation, which comprises a silicon-containing pigment such as silica and a water-based binder, to a base material to improve the shape and density of dots or tone reproducibility in which the above-described ink-jet recording paper of the ordinary plain paper type had been considered to be poor. Further, to obtain surface gloss comparable with that available from silver halide pictures, it has been attempted to apply cast-coating to an ink-receiving layer or to use a superabsorbent polymer in an ink-receiving layer. These attempts are, however, accompanied by drawbacks in that the former cannot provide sufficient gloss and the latter is slower in ink absorption speed than ink-receiving layers formed of fine particles of an inorganic pigment such as silica.

Proposed as ink-jet recording sheets increased in ink absorption property, gloss and transparency were recording media each of which had been obtained by applying a fine alumina hydrate together with a water-soluble binder to a base material. JP 2-276670 A and others disclose recording sheets containing an alumina hydrate of the pseudo-boehmite structure. On the other hand, other patent publications disclose recording sheets, each of which contains an alumina sol of the pseudo-boehmite structure and boric acid or a borate salt. In recording media containing such an inorganic pigment, however, recorded images were caused to fade by light, nitrogen oxides, sulfur oxides or ozone in the air, or the like in some instances and under certain specific conditions, non-printed areas and white backgrounds underwent yellowing.

To avoid these problems, recording media with various antioxidants, ultraviolet absorbers, light stabilizers and/or the like contained therein have been proposed. For example, JP 57-74192 A and others disclose recording media containing phenolic antioxidants, ultraviolet absorbers of the benzophenone or benzotriazole type, hindered amine compounds, hydrazide compounds, undecane compounds, thioether compounds, linear polycarboxylic acids or organic acids having an aromatic nucleus, respectively.

Further, JP 4-34953 B and others disclose recording media each of which contains a thiourea derivative, thiosemicarbazide derivative or thiocarbohydrazide derivative or contains one of thiourea derivatives, thiosemicarbazide derivatives and thiocarbohydrazide derivatives and one of iodine, iodine compounds, dithiocarbamic acids, thiocyanate salts and thiocyanate esters. It is, however, the current circumstances that such conventional approaches are not practical, for example, in that dye migration takes place to result in bleeding of an image when exposed to an environment of high temperature, and high humidity.

As methods for preventing migration of dyes after printing, many methods have been disclosed including addition of a cationic polymer having tertiary or quaternary ammonium salt groups in an ink-receiving layer and addition of a sizing agent such as an alkylketene dimer or alkenyl succinic anhydride in an ink-receiving layer. However, combined use of the above-mentioned antioxidant, light stabilizer or ultraviolet absorber with a cationic polymer or sizing agent involves many problems in that the migration preventing effect is lost and fading of an image is no longer prevented effectively but on the contrary, may be aggravated. It has, therefore, been difficult to prevent dye migration and image fading and discoloration at the same time. Further, when the cationic polymer is added in a greater proportion or depending on its kind, the resulting coating formulation for the formation of the ink-receiving layer tends to gel, developing another problem in that its application results in an ink-receiving layer a surface of which is poor in smoothness and hence, low in gloss.

With the foregoing current circumstances in view, the present invention, therefore, has as an object the provision of a recording medium which provides high image density, exhibits good tone and ink absorption property, is excellent in gloss, and is inhibited in migration of a dye after printing and also in image fading and discoloration by storage over extended time.

### DISCLOSURE OF THE INVENTION

The present inventors have proceeded with various investigations to obtain a recording medium permitting printing of excellent quality and inhibited in image fading and discoloration by storage over extended time and also in dye migration. As a result, it has been found that in a recording medium having an ink-receiving layer composed, as principal components, of an inorganic pigment and at least one binder resin selected from water-soluble resins and water-dispersible resins (which may hereinafter be called simply “a binder resin”), incorporation of a compound represented by the below-described formula (1), an alkylamine-epihalohydrin copolymer and a boron compound in specific proportions in the ink-receiving layer makes it possible to achieve the above-described object, leading to the completion of the present invention.

The present invention, therefore, provides a recording medium composed of a base material and at least one ink-receiving layer arranged on at least one side of the base material. The recording medium is characterized in that the ink-receiving layer comprises:
at least one binder resin selected from a water-soluble resin and a water-dispersible resin,
an inorganic pigment,
a compound represented by the following formula (1): 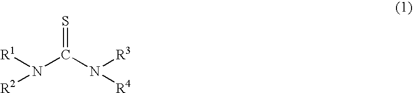
   wherein R¹ to R⁴ may be the same or different and each independently represents a hydrogen atom, an alkyl group, an aryl group or a group represented by —NR⁵R⁶, R⁵ and R⁶ each independently represents a hydrogen atom, an alkyl group having 1 to 5 carbon atoms, a phenyl group or a group represented by —NR⁷CSNR⁸R⁹, R⁷ to R⁹ may be the same or different and each independently represents a hydrogen atom, an alkyl group having 1 to 5 carbon atoms or a phenyl group, and any one of R¹ and R² and any one of R³ and R⁴ are not fused together to form a ring,
an alkylamine-epihalohydrin copolymer, and
a boron compound.

The inorganic pigment, the compound represented by the formula (1), the alkylamine-epihalohydrin copolymer and the boron compound satisfy the following equations (1) and (2):
4×(B+C+D)≦A Equation (1), and
(B/D):C=0.1:5 to 15:0.1 Equation (2)
wherein A represents a proportion in terms of parts by weight of the inorganic pigment, B represents a proportion in terms of parts by weight of the compound represented by the formula (1), C represents a proportion in terms of parts by weight of the alkylamine-epihalohydrin copolymer, and D represents a proportion in terms of parts by weight of the boron compound.

In the above-described recording medium according to the present invention, the ink-receiving layer, at a surface thereof, may preferably have an arithmetic mean roughness (Ra) not greater than 0.1 Am when measured by setting the cut-off value and measurement length at 0.25 mm and 1.25 mm as specified in JIS-B-0601; the inorganic pigment may preferably be at least one of alumina, an alumina hydrate of the boehmite structure and an alumina hydrate of the pseudo-boehmite structure; the alkylamine-epichlorohydrin copolymer may preferably be a cationic polymer represented by the following formula (2): 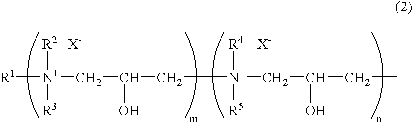
wherein R¹ and R² each independently represents a hydrogen atom, an alkyl group having 1-18 carbon atoms or a benzyl group, R³ represents an alkyl group having 2-18 carbon atoms or a benzyl group, R⁴ and R⁵ each independently represents a hydrogen atom or a methyl group, X⁻ represents a halogen ion, and m and n are integers indicating polymerization degrees, respectively; and the boron compound may preferably be boric acid or a borate salt.

Owing to the arrangement of the above-described ink-receiving layer, the recording medium according to the present invention permits printing of excellent characteristics, that is, formation of images with excellent density and tone while exhibiting superb ink absorption property and is inhibited in image fading and discoloration by storage over extended time and also in dye migration.

### BEST MODES FOR CARRYING OUT THE INVENTION

The present invention will hereinafter be described more specifically based on certain preferred embodiments.

Preferred examples of the base material for use in the present invention can include base materials composed of paper or the like, such as adequately sized paper, non-sized paper, coated paper, cast-coated paper, and resin-coated paper both sides of which are coated with a resin such as a polyolefin (hereinafter referred to as “resin-coated paper”); and transparent films of thermoplastic resins such as polyethylene, polypropylene, polyesters, polylactic acid, polystyrene, polyacetates, polyvinyl chloride, cellulose acetate, polyethylene terephthalate, polymethyl methacrylate and polycarbonates; sheet-like materials (synthetic paper and the like) formed of films opacified by inorganic fillers or fine bubbles; and sheets made of glass or metals.

From the viewpoint of heightening the gloss of the surface of the ink-receiving layer, it is preferred in the present invention to use a resin film or resin-coated paper having no water absorbability and high smoothness. To improve the adhesion strength between these base materials and the ink-receiving layers, corona discharge treatment or various undercoating treatments can be applied to surfaces of these base materials.

The inorganic pigment for use in the present invention may preferably be fine inorganic particles, which have high ink-absorbing ability and excellent color producibility and permit formation of images of high quality. Illustrative of such fine inorganic particles are calcium carbonate, magnesium carbonate, kaolin, clay, talc, hydrotalcite, aluminum silicate, calcium silicate, magnesium silicate, diatomaceous earth, alumina, colloidal alumina, aluminum hydroxide, alumina hydrates of the boehmite structure, alumina hydrates of the pseudo-boehmite structure, synthetic amorphous silica, colloidal silica, lithopone, and zeolite. These materials can be used either singly or in combination.

As the form of the above-described fine inorganic particles, their average particle size may be preferably in a range of from 150 nm to 250 nm, more preferably in a range of from 160 nm to 230 nm for obtaining an ink-receiving layer of high gloss and high transparency. Inorganic fine particles the average particle size of which is smaller than 150 nm lead to a substantial reduction in the ink absorption property of the ink-receiving layer so that, when printed by a printer of high jetting rate, ink bleeding and beading occur. An average particle size greater than 250 nm, on the other hand, results in an ink-receiving layer lowered in transparency and reduced in image print density and gloss. Incidentally, each “average particle size” as referred to herein can be measured by the dynamic light scattering method, and can be determined from an analysis making use of the cumlant method described in “Polymer Structures (2), Scattering Experiments and Form Observations, Chapter 1: Light Scattering” (KYORITSU SHUPPAN CO., LTD.; Compiled by The Society of Polymer Science, Japan) or “J. Chem. Phys., 70(B), 15 Apl., 3965 (1979)”.

The present invention is characterized in that an ink-receiving layer is formed by using the compound represented by the formula (1), the alkylamine-epihalohydrin copolymer, and the boron compound together with the pigment. In the compound represented by the formula (1), R¹ to R⁹ have the same meanings as defined above. When R¹ to R⁴ are alkyl groups, those having 1 to 10 carbon atoms are preferred. When R¹ to R⁴ are aryl groups, phenyl groups or naphthyl groups are preferred. These alkyl and aryl groups may each be unsubstituted or substituted.

Specific examples of the compound represented by the formula (1) can include those to be described hereinafter. Firstly, illustrative of the compound represented by the formula (1) in which R¹ to R⁴ each represents a hydrogen atom, an alkyl group or an aryl group are:

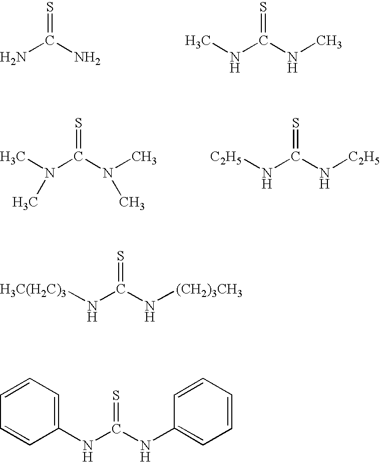

Illustrative of the compound represented by the formula (1) in which at least one of R¹ to R⁴ is a group represented by —NR⁵R⁶ are:

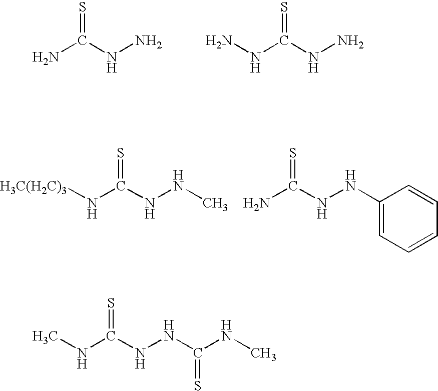

From the viewpoint of ink absorption property and image fading and discoloration preventing effects, the compound represented by the formula (1) may be contained preferably in a proportion of from 0.1 to 20 parts by weight per 100 parts by weight of the inorganic pigment. The more preferred range is from 0.5 to 15 parts by weight per 100 parts by weight of the inorganic pigment. In this more preferred range, ink bleeding or beading hardly occur.

In the present invention, the boron compound is used along with the compound represented by the formula (1). The boron compound for use in the present invention may preferably be an oxyacid formed around a boron atom as a center or a salt thereof, such as boric acid or a borate salt. Specific examples can include orthophosphoric acid, metaphosphoric acid, hypoboric acid, tetraboric acid and pentaboric acid, and salts thereof.

Boric acid is commonly used as a hardener for improving the film-forming properties, waterproofness and film strength of films formed of hydrophilic polymers. Depending upon the types of reactive groups contained in polymers to be used, various hardeners are chosen, respectively. In the case of a polyvinyl alcohol resin, for example, an epoxy hardener or an inorganic hardener such as boric acid or a water-soluble aluminum salt is used. However, the role of the boron compound in the present invention is to increase the fading preventing effect or the discoloration preventing effect for images when incorporated especially along with the compound represented by the formula (1) in the recording medium, and therefore, is different from that of the same compound in the application where its utility is limited to the effect as a hardener.

To bring about both of the synergistic effect for the prevention of fading and discoloration of images and the good coating work stability, the boron compound may be contained preferably in a proportion of from 0.5 to 5 parts by weight per 100 parts by weight of the inorganic pigment. More preferably, the boron compound may be contained in a proportion of from 1 to 5 parts by weight per 100 parts by weight of the inorganic pigment, and the mixing weight ratio of the boron component to the compound represented by the formula (1) may desirably satisfy the following equation (3):
0.1≦B/D≦15 Equation (3)
wherein B and D have the same meanings as defined above. Insofar as B/D falls within this range, improved fading preventing effect and discoloration preventing effect can be brought about for images.

In the present invention, it is preferred to form an ink-receiving layer by using the alkylamine-epihalohydrin copolymer in combination with the compound represented by the formula (1) and the boron compound. The alkylamine-epihalohydrin copolymer for use in the present invention is a polymer containing groups of a quaternary ammonium salt, said groups showing cationic properties, and is a copolymer composed of two different types of amine-epihalohydrin units as shown above by the formula (2).

In the formula (2), R¹ to R⁵ and X⁻ have the same meanings as defined above. As the epihalohydrin as structural units in the copolymer for use in the present invention, epichlorohydrin is advantageous in cost, and in this case, X⁻ is a chlorine ion. The molar ratio m:n of the first structural unit (the left-hand constituent in the formula (2)) to the second structural unit (the right-hand constituent in the formula (2)) in the copolymer may preferably range from 1:1 to 1:50. The ratio of the structural units affects the compatibility of the copolymer with the inorganic pigment and binder and the waterproofness of the ink-receiving layer. To provide the copolymer with both properties in a well-balanced manner, it is generally desired to set their ratio within the following range in accordance with the carbon numbers of R² and R³ in the first structural unit.

When the carbon numbers of R² and R³ are each 12 or greater, for example, m:n may preferably range from 1:15 to 1:50. When the carbon numbers of R² and R³ are each smaller than 12, on the other hand, m:n may preferably range from 1:1 to 1:15. In the above-mentioned ranges, more preferred are copolymers in each of which R⁴ and R⁵ are methyl groups, respectively, and R² and R³ each has an average carbon number of from 6 to 18, and copolymers in each of which R² and R³ each has an average carbon number of from 8 to 12 can be used especially preferably. As the arrangement of the first structural units and the second structural units, any arrangement is usable including random copolymer, alternating copolymer, block copolymer or multi-block copolymer. These copolymers can be used either singly or in combination.

Concerning the process for the polymerization of an alkylamine and epichlorohydrin, JP 38-26794 B discloses a process for obtaining a water-soluble polymer by reacting ammonia and epichlorohydrin, and further, JP 43-243 B discloses a process for producing a water-soluble polymer by a reaction between dimethylamine and epichlorohydrin. The alkylamine-epihalohydrin copolymer employed in the present invention can also be produced by a process similar to the above-described production processes of the polymers. No particular limitation is imposed on the weight average molecular weight of the alkylamine-epihalohydrin copolymer employed in the present invention, although it may range preferably from 1,000 to 200,000, more preferably from 5,000 to 200,000. A weight average molecular weight lower than 1,000 leads to recorded images of insufficient waterproofness, whereas a weight average molecular weight higher than 200,000 results in a coating formulation the viscosity of which is too high to permit easy handling upon formation of an ink-receiving layer. Further, an alkylamine-epihalohydrin copolymer of high molecular weight tends to lead to a reduction in the efficiency of bonding with dye molecules due to steric hindrance by its molecular structure so that its waterproofness imparting effect cannot be sufficiently brought about especially when it is added in a small proportion.

The above-described alkylamine-epihalohydrin copolymer, which is employed in the present invention, is generally used as a dye fixative to permit formation of images with improved waterproofness on the recording medium. Such a dye fixative forms a salt with a dye having one or more anionic groups and makes the dye insoluble in water, so that images can be formed with improved waterproofness. It is, however, to be noted that, when the alkylamine-epihalohydrin copolymer useful in the present invention is used in an ink-receiving layer, in which the compound represented by the formula (1) and the boron compound are contained together, as described above, the alkylamine-epihalohydrin copolymer can impart waterproofness and dye migration preventing effect and moreover, can further improve the effect for the prevention of fading and discoloration of images.

The proportion of the alkyl-epihalohydrin copolymer to be used also varies depending on the proportion of the inorganic pigment and the proportion of the binder resin to be used as a binder. In general, however, it is preferred to add the acrylamide-diallylamine hydrochloride copolymer and/or the polyallylamine acetate in a proportion of from 0.05 to 5 parts by weight per 100 parts by weight of the inorganic pigment. Further, the mixing weight ratio of the compound represented by the formula (1), the alkylamine-epihalohydrin copolymer and the boron compound to be used in the present invention may preferably be set within the range defined by the following equation (2):
(B/D):C=0.1:5 to 15:0.1 Equation (2)
wherein B, C and D have the same meanings as defined above.

When the alkylamine-epihalohydrin copolymer falls within the above range relative to B/D, recording media further improved in the fading and discoloration preventing effect for images can be obtained with excellent dye migration preventing effect.

In the present invention, it is also preferred to add the compound represented by the formula (1), the alkylamine-epihalohydrin copolymer, and the boron compound at such a mixing weight ratio that, within the range satisfying (B/D):C=0.1:5 to 15:0.1 (Equation 2), they satisfy 4×(B+C+D)≦A (Equation 1) wherein A, B, C and D have the same meanings as defined above, that is, the sum of B, C and D is 25 parts by weight or smaller per 100 parts by weight of the inorganic pigment. More preferably, (B+C+D) may fall within a range of from 0.65 to 25 parts by weight per 100 parts by weight of the inorganic pigment. If (B+C+D) exceeds 25 parts by weight, the viscosity of a coating formulation used to form an ink-receiving layer will undergo substantial variations with time, possibly leading to a reduction in the stability of coating work. If (B+C+D) is smaller than 0.65 part by weight, on the other hand, the image fading and discoloration preventing effect and the migration inhibiting effect, both of which are objectives of the present invention, may not be fully brought about in some instances.

The recording medium according to the present invention can be obtained by preparing a coating formulation of the above-described components and then applying the coating formulation to a surface of a base material to form an ink-receiving layer. This ink-receiving layer may preferably include voids, which are formed by the inorganic pigment and a small amount of the binder resin. For the availability of smaller voids, use of alumina, an alumina hydrate of the boehmite structure or an alumina hydrate of the pseudo-boehmite structure as the inorganic pigment is preferred. Particularly preferred is alumina or an alumina hydrate of the boehmite structure or pseudo-boehmite structure, which has a BET specific surface area of 50 m²/g or greater, with a range of from 50 to 500 m²/g being more preferred. A BET specific surface area smaller than 50 m²/g means large alumina hydrate particles, results in an ink-receiving layer with impaired transparency, and tends to give images which are low in density and look as if covered with a white haze. A BET specific surface area greater than 500 m²/g, on the other hand, leads to a reduction in ink absorption property and requires a great deal of an acid for the deflocculation of the alumina hydrate. Still more preferred is a range of from 50 to 250 m²/g, which can form an ink-receiving layer excellent in ink absorption property, beading (a phenomenon that grain-shaped, density irregularity occurs due to a failure in absorbing ink) resistance, smoothness and the like.

An alumina hydrate usable in the present invention can be represented by the following formula (3):
Al₂O₃₋ₙ(OH)₂ₙ.mH₂O (3)
wherein n stands for any one of integers 0, 1, 2 and 3, and m stands for a value of from 0 to 10, preferably from 0 to 5. Because mH₂O represents a removable water phase which may not take part in the formation of a crystal lattice in many instances, m can stands for a value which is not an integer. It is to be noted that m may reach the value of 0 when an alumina hydrate of this sort is subjected to calcination.

In general, an alumina hydrate showing the boehmite structure is a layer compound the (020) crystal plane of which forms a huge plane, and shows a particular diffraction peak in its X-ray diffraction pattern. As the boehmite structure, it is possible to take, in addition to complete boehmite structure, a structure containing excess water between layers of (020) planes and called “pseudo-boehmite”. An X-ray diffraction pattern of this pseudo-boehmite shows a broader diffraction peak than complete boehmite. As complete boehmite and pseudo-boehmite are not clearly distinguishable from each other, they will hereinafter be collectively called an alumina hydrate showing the boehmite structure unless otherwise specifically indicated.

No particular limitation is imposed on the process for the production of an alumina hydrate which has the boehmite structure and is included in a recording medium according to the present invention. It can, therefore, be produced by any known process insofar as it can produce an alumina hydrate having the boehmite structure, for example, by hydrolysis of an aluminum alkoxide or hydrolysis of sodium aluminate.

As disclosed in JP 56-120508 A, an aluminum hydrate which is amorphous as determined by its X-ray diffraction can also be used by subjecting it to heat treatment at 50° C. or higher in the presence of water and converting its structure into the boehmite structure. As a process usable especially preferably, an alumina compound can be obtained by adding an acid to a long-chain aluminum alkoxide and conducting its hydrolysis and deflocculation.

The term “long-chain aluminum alkoxide” as used herein means an alkoxide having 5 or more carbon atoms. Use of an aluminum alkoxide having 12 to 22 carbon atoms is preferred because such a long-chain aluminum alkoxide facilitates elimination of the alcoholic moiety and shape control of the resulting aluminum hydrate as will be described subsequently herein.

As the acid to be added, one or more acids can be chosen at will from organic acids and inorganic acids, and can be used. Nitric acid is most preferred from the standpoint of the efficiency of the hydrolytic reaction and the shape control and dispersibility of the resulting aluminum hydrate. Subsequent to this step, a hydrothermal synthesis can be conducted to control the particle size. When the hydrothermal synthesis is conducted by using an alumina hydrate dispersion which contains nitric acid, the nitric acid in the dispersion is attracted as nitrate groups on surfaces of the alumina hydrate so that the alumina hydrate is improved in water dispersibility.

The above-described process has a merit in that, compared with production processes of alumina hydrogel or cationic alumina, impurities such as various types of ions can be hardly mixed in. Further, a long-chain aluminum alkoxide has another merit in that, because an alcohol can be readily eliminated subsequent to hydrolysis, the dealcoholation of the alumina hydrate can be effected completely compared with use of a short-chain alkoxide such as aluminum isopropoxide.

The recording medium according to the present invention can be obtained by mixing a composition, which comprises the inorganic pigment, the compound represented by the formula (1), the alkylamine-epihalohydrin copolymer and the boron compound, with a binder resin and an aqueous medium in amounts as much as needed into a coating formulation, applying the coating formulation to a surface of a base material and then drying the thus-applied coating formulation into an ink-receiving layer.

As the construction of the recording medium according to the present invention, it is possible to choose a construction with an ink-receiving layer arranged on a base material like coated paper or coated film; a construction with an ink-receiving layer formed by impregnating a base material with a portion or a major portion of a coating formulation in the vicinity of a surface of the base material; or a construction with an ink-receiving layer formed by applying a small amount of a coating formulation to a surface of a base material. In the present invention, these constructions shall all be embraced by the expression that “an ink-receiving layer is formed on a surface of a base material”.

Illustrative of the binder resin which is included in the coating formulation are starch, gelatin and casein, and modified products thereof; cellulose derivatives such as methylcellulose, carboxymethylcellulose and hydroxyethylcellulose; completely or partially saponified polyvinyl alcohols and modified products thereof (including those modified with cations, anions, silanols or the like); urea resins; melamine resins; epoxy resins; epichlorohydrin resins; polyurethane resins; polyethylene-imine resins; polyamide resins; polyvinyl pyrrolidone resins; polyvinyl butyral resins; poly(meth)acrylic acid and copolymers thereof; acrylamide resins; maleic anhydride copolymers; polyester resins; SBR latex; NBR latex; methyl methacrylate-butadiene copolymer latex; acrylic polymer latexes such as acrylate ester copolymers; vinyl polymer latexes such as ethylene-vinyl acetate copolymer; and functional-group-modified polymer latexes formed by bonding cationic groups or anionic groups to a variety of these polymer latexes. Preferred is polyvinyl alcohol obtained by hydrolyzing polyvinyl acetate and having an average polymerization degree of from 300 to 5,000. Its saponification degree may preferably be from 70 to lower than 100%, with 80 to 99.5% being particularly preferred. These water-soluble or water-dispersible resins can be used either singly or in combination.

The mixing weight ratio of the inorganic pigment to the binder resin in the coating formulation may preferably be in a range of from 1:1 to 30:1, with a range of from 3:1 to 20:1 being more preferred. Setting of the proportion of the binder resin within this range makes it possible to provide the resulting ink-receiving layer with resistance to crazing or separation as dust and also with good ink absorption property.

No particular limitation is imposed on the aqueous medium in the coating formulation, insofar as it is water or a mixture of water and a water-miscible organic solvent. Examples of the water-miscible organic solvent can include alcohols such as methanol, ethanol and propanol; lower alkyl ethers of polyhydric alcohols, such as ethylene glycol monomethyl ether and ethylene glycol dimethyl ether; ketones such as acetone and methyl ethyl ketone; and ethers such as tetrahydrofuran.

No particular limitation is imposed on the concentration of solids in the coating formulation adapted to form an ink-receiving layer, insofar as the coating formulation has a viscosity sufficient to form the ink-receiving layer on the base material. The preferred solid concentration may, however, range from 5 to 50% by weight based on the whole weight of the coating formulation. A solid concentration lower than 5 wt. % leads to a need for increasing the coat weight to form an ink-receiving layer of sufficient thickness. As longer time and greater energy are required for drying, such a low solid concentration may not be economical in some instances. A solid concentration higher than 50 wt. % , on the other hand, results in a coating formulation of high viscosity, and the coatability may be reduced in some instances.

To apply such a coating formulation to a base material, a conventionally-known coating method can be used, such as spin coating, roll coating, blade coating, air knife coating, gate roll coating, bar coating, size pressing, spray coating, gravure coating, curtain coating, rod blade coating, lip coating, or slit die coating. Subsequent to the coating, the surface smoothness of the ink-receiving layer can be improved by using a calender roll or the like as needed.

The surface of the ink-receiving layer of the recording medium according to the present invention obtained as described above may preferably have an arithmetic mean roughness (Ra) of 0.1 μm or lower when measured by setting the cut-off value and measurement length at 0.25 mm and 1.25 mm as specified in JIS-B-0601. Use of the construction of the present invention for an ink-receiving layer in combination with a high-smoothness base material such as a resin-coated paper or film makes it possible to obtain a high-smoothness surface without needing any additional treatment or processing after application of a coating formulation.

As a coat weight of the coating formulation to the base material, the preferred range is from 0.5 to 60 g/m², and the more preferred range is from 5 to 55 g/m². A coat weight smaller than 0.5 g/m² may result in formation of an ink-receiving layer incapable of absorbing water sufficiently from ink so that the ink may run off or an image may bleed. A coat weight greater than 60 g/m², on the other hand, leads to occurrence of curling on a recording medium upon drying so that concerning printing performance, advantageous effects may not be brought about to such marked extent as expected.

As a method for using the compound represented by the formula (1) and the alkylamine-epihalohydrin copolymer, the compound represented by the formula (1) and the alkylamine-epihalohydrin copolymer can be added directly to a coating formulation as described above or by adding them to a recording medium on which an ink-receiving layer has been formed with the inorganic pigment and other component(s). In the case of the latter method, the compound represented by the formula (1) and the alkylamine-epihalohydrin copolymer can be added to the ink-receiving layer by dissolving or dispersing them in a solvent beforehand and immersing the recording medium in the solution or overcoating the solution to the recording medium.

The recording medium according to the present invention can be obtained by applying the coating formulation to the base material by one of these coating methods and drying the thus-applied coating formulation in a drier such as a hot air drier, hot drum or far-infrared drier. The base material can be provided on one side thereof with an ink-receiving layer or on both sides thereof with ink-receiving layers, respectively. When ink-receiving layers are applied to both sides, respectively, these ink-receiving layers may have the same composition or different compositions.

To the ink-receiving layer of the recording medium according to the present invention, other materials can be added to extents not impairing its performance as a recording medium. Examples of such other materials can include mordant dyes, mordant pigments, dispersants, thickeners, pH adjusters, lubricants, flow modifiers, surfactants, antistatic agents, defoamers, foam inhibitors, penetrants, fluorescent whitening agents, ultraviolet absorbers, and antioxidants.

Although it is not clear why the recording medium of the present invention as described above permits printing of excellent quality and especially exhibits superb effects for the inhibition of fading and discoloration of images by storage over extended time, certain interactions appear to take place among the compound represented by the formula (1), the boron compound and the alkylamine-epihalohydrin copolymer to develop such effects.

No particular limitation is imposed on ink to be used upon making a record on the recording medium according to the present invention. It is, however, preferred to use general water-base ink for ink-jet recording, in which a dye or pigment is used as a colorant, a mixture of water and a water-miscible organic solvent is used as a medium, and the dye or pigment is dissolved or dispersed in the medium.

As a method for performing the formation of an image by applying the above-described ink onto the recording medium according to the present invention, ink-jet recording is particularly suited. Any ink-jet recording process can be used insofar as it can apply an ink to a recording medium by effectively causing the ink to fly off from a nozzle. A particularly useful process is an ink-jet recording process such as that disclosed in JP 54-59936 A or the like, in which as a result of exposure to action of thermal energy, an ink undergoes a rapid change in volume and the resulting force forces the ink to jet out.

### EXAMPLES

The present invention will hereinafter be described still more specifically based on Examples and Comparative Examples, in which each designation of “part” or “parts” or “%” is on a weight basis unless otherwise specifically indicated.

Rankings and measurements of various physical properties of each recording medium in the present invention were conducted by the following methods.

<Ranking 1: Fading and Discoloration Inhibiting Effects>

On each recording medium, solid printing (ink dot area: 100%) was performed with single-color inks of yellow (Y), magenta (M), cyan (C) and black (Bk) by using an ink-jet recording machine (“BJ F900”, trade name; manufactured by Canon Inc.). By ozone exposure testing equipment (manufactured by SUGA TEST INSTRUMENTS CO., LTD.; special order equipment), the recorded medium was exposed to 3 ppm ozone for 2 hours at 40° C. and 55% RH. Changes in color perception at the printed areas were visually ranked. Recording media were ranked “A” where no difference in color perception was observed with respect to any of the colors, recording media were ranked “B” where a slight difference in color perception was observed with respect to at least one of the colors, and recording media were ranked “C” where a significant difference in color perception was observed with respect to at least one of the colors.

<Ranking 2: Migration Preventing Effect>

Using the ink-jet recording machine (“BJ F900”, trade name; manufactured by. Canon Inc.), solid printing (ink dot area: 100%) was performed with the single-color inks of yellow (Y), magenta (M), cyan (C) and black (Bk) on each recording medium. The recorded medium was exposed for 1 week to an environment of 30° C. and 80% RH. Degrees of migration of the individual dyes were visually ranked. Recording media were ranked “A” where no migration took place with respect to any of the colors, recording media were ranked “B” where slight migration took place with respect to at least one of the colors, and recording media were ranked “C” where significant migration took place with respect to at least one of the colors.

<Measurement 1: Surface Roughness>

Using a surface profile or roughness measuring instrument “Form Talysurf S5” (trade name, manufactured by Taylor Hobson Ltd.), the arithmetic mean roughness Ra (μm) of the surface of the ink-receiving layer on each recording medium was measured by setting the cut-off value and measurement length at 0.25 mm and 1.25 mm as specified in JIS-B-0601.

<Measurement 2: Gloss>

Using a glossmeter (“VG-2000, trade name; manufactured by Nippon Denshoku Industries Co., Ltd.), the 75-deg. Specular gloss, as specified in JIS-Z-8741, of the surface of the ink-receiving layer on each recording medium was measured.

<Preparation of a Dispersion of Alumina Hydrate>

Following the process disclosed in U.S. Pat. No. 4,242,271, aluminum dodexide was prepared. Following the process disclosed in U.S. Pat. No. 4,202,870, the aluminum dodexide was then hydrolyzed to prepare an alumina slurry. Water was added to the alumina slurry until the content of an alumina hydrate reached 7.7%. At that time, the pH of the alumina slurry was 9.4. A 3.9% nitric acid solution was added to the slurry to adjust its pH.

Using an autoclave, the slurry (pre-aging pH: 6.0) was then subjected to aging (aging temperature: 150° C., aging time: 6 hours) to obtain a colloidal sol. The colloidal sol was spray-dried into an alumina hydrate powder at an inlet temperature of 87° C. The powder so obtained was an alumina hydrate, the particle shape and crystal structure of which were plate-like and the boehmite structure, respectively. Using a specific surface area and pore distribution measuring instrument (“Micromeritics ASAP2400”, trade name; manufactured by Shimadzu Corporation), the BET specific surface area of the thus-obtained powder was measured. It was found to be 140.5 m²/g. Further, the alumina hydrate powder having the boehmite structure was mixed at a concentration of 17% in deionized water to prepare an alumina hydrate dispersion A.

<Alkylamine-Epihalohydrin Copolymer>

As an alkylamine-epihalohydrin copolymer, “JK-181” (trade name; 50% aqueous solution; product of Meisei Chemical Works, Ltd.) was used. “JK-181” is a polyamine base polymer, and as an analysis of its molecular structure by a nuclear magnetic resonance system “JNM-ECA500” (trade name, manufactured by JEOL, Ltd.) and a GC-combined mass spectrometer “HP 6890 Series” (trade name, manufactured by Hewlett-Packard Company), the average carbon numbers of R² and R³ shown in formula (2) were each found to range from 8 to 12.

### Example 1

The alumina hydrate dispersion A was agitated at 2,000 rpm for 5 minutes in a homomixer (manufactured by Tokushu Kika Kogyo Co., Ltd.) to obtain a dispersion B. As a result of a measurement of the thus-obtained dispersion B by a laser diffraction particle size analyzer (“PARIII”, trade name; manufactured by OTSUKA ELECTRONICS CO., LTD.), the average particle size of particles of the alumina hydrate was determined to be 174.3 nm. Mixed in the dispersion B (100 parts) were N,N′-diethylthiourea (0.340 part, 2% based on the alumina hydrate), a 3% aqueous solution of boric acid (17.0 parts, 3% based on the alumina hydrate), and the above-described “JK-181” (0.340 part, 1% based on the alumina hydrate) as an allkylamine-epihalohydrin copolymer. To the resulting mixture, a solution (17.0 parts) of polyvinyl alcohol (5 parts; “PVA-224”, trade name; product of Kuraray Co., Ltd.) in deionized water (45 parts) was added to prepare a coating formulation. Using resin-coated paper of 234 g/m² in basis weight (product of Oji Paper Co., Ltd.) as a base material, the above-prepared coating formulation was applied to the base material by die coating to give a dry coat weight of 30 g/m². The thus-coated base material was then placed in an oven (manufactured by Yamato Scientific Co., Ltd.), in which the coated base material was dried at 100° C. for 30 minutes to form an ink-receiving layer. Using the thus-obtained recording medium, the above-described tests for the rankings 1 and 2 and the measurements 1 and 2 were conducted. The results are presented in Table 1.

### Example 2

A recording medium was prepared in a similar manner as in Example 1 except that the amounts of the 3% aqueous solution of boric acid and “JK-181” were changed to 11.33 parts (2% based on the alumina hydrate) and 0.170 part (0.5% based on the alumina hydrate), and ranking and measurement tests were conducted. The results are presented in Table 1.

### Example 3

A recording medium was prepared in a similar manner as in Example 1 except that N,N′-dimethylthiourea (0.170 part, 1% based on the alumina hydrate) was used in place of N,N′-diethylthiourea and the amounts of the 3% aqueous solution of boric acid and “JI-181” were changed to 5.67 parts (1% based on the alumina hydrate) and 0.034 part (0.1% based on the alumina hydrate), respectively, and ranking and measurement tests were conducted. The results are presented in Table 1.

### Example 4

A recording medium was prepared in a similar manner as in Example 1 except that thiosemicarbazide (1.19 parts, 7% based on the alumina hydrate) was added in place of N,N′-diethylthiourea and the amounts of the 3% aqueous solution of boric acid and “JK-181” were changed to 2.83 parts (0.5% based on the alumina hydrate) and 1.53 parts (4.5% based on the alumina hydrate), respectively, and ranking and measurement tests were conducted. The results are presented in Table 1.

### Example 5

A recording medium was prepared in a similar manner as in Example 4 except that the amounts of thiosemicarbazide, 3% aqueous solution of boric acid and “JK-181” were changed to 2.55 parts (15% based on the alumina hydrate), 25.5 parts (4.5% based on the alumina hydrate) and 1.02 parts (3% based on the alumina hydrate), respectively, and ranking and measurement tests were conducted. The results are presented in Table 1.

### Comparative Example 1

A recording medium was prepared in a similar manner as in Example 2 except that “JK-181” was not added, and ranking and measurement tests were conducted. The results are presented in Table 1.

### Comparative Example 2

A recording medium was prepared in a similar manner as in Example 2 except that N,N′-diethylthiourea was not added, and ranking and measurement tests were conducted. The results are presented in Table 1.

### Comparative Example 3

A recording medium was prepared in a similar manner as in Example 2 except that neither N,N′-diethylthiourea nor “JK-181” was added, and ranking and measurement tests were conducted. The results are presented in Table 1.

### Comparative Example 4

A recording medium was prepared in a similar manner as in Example 2 except that “PAA-HCl-3L” (trade name for polyallylamine acetate polymer, 50% aqueous solution; product of Nitto Boseki Co., Ltd.) was added in a proportion of 0.170 part (0.5% based on the alumina hydrate) in place of “JK-181”, and ranking and measurement tests were conducted. The results are presented in Table 1.

### Comparative Example 5

A recording medium was prepared in a similar manner as in Example 2 except that “Sunfix 414” (trade name for polyalkylenepolyamine-dicyandiamide polycondensation product, 50% aqueous solution; product of Sanyo Chemical Industries, Ltd.) was added in a proportion of 0.170 part (0.5% based on the alumina hydrate) in place of “JK-181”, and ranking and measurement tests were conducted. The results are presented in Table 1.

### Comparative Example 6

A recording medium was prepared in a similar manner as in Example 2 except that “PAS-M-1” (trade name for diallylmethylamine hydrochloride polymer, 60% aqueous solution; product of Nitto Boseki Co., Ltd.) was added in a proportion of 0.142 part (0.5% based on the alumina hydrate) in place of “JK-181”, and ranking and measurement tests were conducted. The results are presented in Table 1.

### Comparative Example 7

A recording medium was prepared in a similar manner as in Example 2 except that boric acid was not added, and ranking and measurement tests were conducted. The results are presented in Table 1.

### Comparative Example 8

A recording medium was prepared in a similar manner as in Example 4 except that the amounts of thiosemicarbazide, the 3% aqueous solution of boric acid and “JK-181” were changed to 3.40 parts (20% based on the alumina hydrate), 17.0 parts (3% based on the alumina hydrate) and 1.02 parts (3% based on the alumina hydrate), respectively, and ranking and measurement tests were conducted. The results are presented in Table 1.

TABLE 1

| | Fading and | Migration | Surface | |
|---|---|---|---|---|
| | discoloration | preventing | roughness | 75-deg. |
| | inhibiting effect | effect | Ra (μm) | Gloss |
| Example 1 | A | A | 0.087 | 62.7 |
| Example 2 | A | A | 0.043 | 68.3 |
| Example 3 | A | A | 0.036 | 68.0 |
| Example 4 | A | A | 0.067 | 60.2 |
| Example 5 | A | A | 0.118 | 56.5 |
| Comp. Ex. 1 | B | C | 0.029 | 72.6 |
| Comp. Ex. 2 | C | A | 0.048 | 65.1 |
| Comp. Ex. 3 | C | C | 0.031 | 69.9 |
| Comp. Ex. 4 | C | B | 0.089 | 62.4 |
| Comp. Ex. 5 | B | C | 0.062 | 61.0 |
| Comp. Ex. 6 | B | C | 0.120 | 54.5 |
| Comp. Ex. 7 | B | B | 0.039 | 63.8 |
| Comp. Ex. 8 | A | C | 0.125 | 51.6 |

As is evident from the above Examples and Comparative Examples, the recording media according to the present invention each of which contained the compound represented by the formula (1), the alkylamine-epihalohydrin copolymer preferably having a specific structure and the boron compound in its ink-receiving layer effectively inhibited ozone-related discoloration and fading of images and was excellent in indoor image fastness. At the same time, dye migration under an environment of high temperature and high humidity was also prevented, thereby exhibiting superb storability of images over extended time. Furthermore, the use of the construction of an ink-receiving layer according to the present invention in combination with a base material having high smoothness, such as resin-coated paper or a film, made it possible to obtain a surface of high smoothness without needing any additional treatment or processing after the coating.

### INDUSTRIAL APPLICABILITY

Incorporation of an inorganic pigment, a compound represented by the formula (1), an alkylamine-epihalohydrin copolymer and a boron compound at a specific ratio in an ink-receiving layer can provide a recording medium permitting printing of excellent quality and inhibited in image fading and discoloration by storage over extended time and also in dye migration after printing.

1. A recording medium composed of a base material and at least one ink-receiving layer arranged on at least one side of said base material, characterized in that said ink-receiving layer comprises:
at least one binder resin selected from a water-soluble resin and a water-dispersible resin,
an inorganic pigment,
a compound represented by the following formula (1): 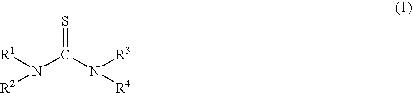
wherein R¹ to R⁴ may be the same or different and each independently represents a hydrogen atom, an alkyl group, an aryl group or a group represented by —NR⁵R⁶, R⁵ and R⁶ each independently represents a hydrogen atom, an alkyl group having 1 to 5 carbon atoms, a phenyl group or a group represented by —NR⁷CSNR⁸R⁹, to R⁹ may be the same or different and each independently represents a hydrogen atom, an alkyl group having 1 to 5 carbon atoms or a phenyl group, and any one of R¹ and R² and any one of R³ and R⁴ are not fused together to form a ring,
an alkylamine-epihalohydrin copolymer, and
a boron compound,
wherein said inorganic pigment is at least one of an alumina hydrate of the boehmite structure and an alumina hydrate of pseudo-boehmite structure and has a bet specific surface area of from 50 to 500 m²/g; and
said inorganic pigment, said compound represented by the formula (1), said alkylamine-epihalohydrin copolymer and said boron compound satisfy the following equations (1) and (2):
4×(B+C+D)≦A Equation (1), and
(B/D):C=0.1:5 to 15:0.1 Equation (2)
wherein A represents a proportion in terms of parts by weight of said inorganic pigment, B represents a proportion in terms of parts by weight of said compound represented by the formula (1), C represents a proportion in terms of parts by weight of said alkylamine-epihalohydrin copolymer, and D represents a proportion in terms of parts by weight of said boron compound.

2. A recording medium according to claim 1, wherein said base material is a resin film or resin-coated paper.

3. A recording medium according to claim 1, wherein said ink-receiving layer has at a surface thereof an arithmetic mean roughness (Ra) not greater than 0.1 μm when measured by setting the cut-off value and measurement length at 0.25 mm and 1.25 mm as specified in JIS-B-0601.

4. (canceled)

5. A recording medium according to claim 1, wherein said inorganic pigment has an average particle size of from 150 nm to 250 nm.

6. (canceled)

7. A recording medium according to claim 1, wherein said compound represented by the formula (1) is used in a proportion of from 0.1 to 20 parts by weight per 100 parts by weight of said inorganic pigment.

8. A recording medium according to claim 1, wherein said alkylamine-epichlorohydrin copolymer is a cationic polymer represented by the following formula (2); 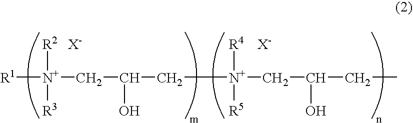
wherein R¹ and R² each independently represents a hydrogen atom, an alkyl group having 1-18 carbon atoms or a benzyl group, R³ represents an alkyl group having 2-18 carbon atoms or a benzyl group, R⁴ and R⁵ each independently represents a hydrogen atom or a methyl group, X⁻ represents a halogen ion, and m and n are integers indicating polymerization degrees, respectively.

9. A recording medium according to claim 8, wherein said copolymer represented by the formula (2) is used in a proportion of from 0.05 to 5 parts by weight per 100 parts by weight of said inorganic pigment.

10. A recording medium according to claim 8, wherein in said copolymer represented by the formula (2), m:n ranges from 1:1 to 1:50.

11. A recording medium according to claim 8, wherein said copolymer represented by the formula (2) has a weight average molecular weight of from 1,000 to 200,000.

12. A recording medium according to claim 1, wherein said boron compound is a boric acid or a borate salt.

13. A recording medium according to claim 1, wherein said boron compound is used in a proportion of from 0.5 to 5 parts by weight per 100 parts by weight of said inorganic pigment.
